(19) United States
(12) Patent Application Publication
(10) Pub. No.: US 2022/0034395 A1
(43) Pub. Date: Feb. 3, 2022

(54) ACTUATOR ASSEMBLY THAT MAXIMIZES FATIGUE STRENGTH AND MECHANICAL ENDURANCE AND PROVIDES INGRESS PROTECTION

(71) Applicant: Vector Horizon Technology, LLC, Bowling Green, KY (US)

(72) Inventors: Oswald Baasch, Bowling Green, KY (US); Stefan B. Holder, Alvaton, KY (US); Jon A. Bigley, Bowling Green, KY (US)

(21) Appl. No.: 16/942,160

(22) Filed: Jul. 29, 2020

(51) Int. Cl. F16H 57/029; F16H 55/17; F16J 15/00; F16J 15/32; F16J 15/447

(52) U.S. Cl. CPC F16H 57/029; F16H 55/17; F16J 15/447; F16J 15/32; F16J 15/002

(57) ABSTRACT

A drive gear adapted to be disposed in a gear box includes a body having a perimeter and a skirt that extends outwardly from the perimeter of the body. A plurality of teeth extends outwardly from the body along a portion of the perimeter of the body. An opening extends through the body and is defined by an inner surface of the body. The inner surface includes a plurality of planar portions and a plurality of rounded portions that extend between the plurality of planar portions. The plurality of planar portions is arranged such that a force (e.g., a torque) applied to the body is directed toward the plurality of teeth.

### FIELD OF THE DISCLOSURE

The present disclosure relates generally to actuator assemblies and, in particular, to an actuator assembly that maximizes fatigue strength and mechanical endurance and provides ingress protection.

### BACKGROUND OF THE DISCLOSURE

Actuators are often utilized in, for example, food and beverage applications, commercial vehicle applications, and other industrial applications. In those applications, the electrical components and the mechanical components of the actuator are often exposed to fluids from wash downs (as part of daily maintenance), accidental fluid spills, or splashes. It will be appreciated that these spills or splashes can short circuit one or more of the electrical components, corrode one or more of the mechanical components, or otherwise interfere with the operation of the actuator, thereby shortening the useful life of the actuator over time.

### BRIEF DESCRIPTION OF THE DRAWINGS

FIG. 1 is a first perspective view of an example actuator assembly constructed in accordance with the teachings of the present disclosure;

FIG. 2 is a second perspective view of the actuator assembly of FIG. 1;

FIG. 3 is a cross-section of the actuator assembly of FIG. 2 taken along line A-A;

FIG. 4 is a plan view of a cross-section of the actuator assembly of FIG. 2 taken along line the C-C

FIG. 5 is a detailed view of a portion of FIG. 4;

FIG. 6 illustrates a detailed view of another portion of FIG. 4;

FIG. 7 illustrates a perspective view of an example drive gear constructed in accordance with the teachings of the present disclosure and employed in the actuator assembly of FIG. 1;

FIG. 8 is a top view of the drive gear of FIG. 7;

FIG. 9 is a bottom view of the drive gear of FIG. 7; and

FIG. 10 is a side view of the drive gear of FIG. 7.

### SUMMARY OF THE DISCLOSURE

In accordance with a first aspect, a drive gear is provided. The drive gear includes a body having a perimeter and a skirt that extends outwardly from the perimeter of the body. The drive gear also includes a plurality of teeth that extend outwardly from the body and extend along a portion of the perimeter of the body. An opening extending through the body and is defined by an inner surface of the body. The inner surface includes a plurality of planar portions and a plurality of rounded portions that extend between the plurality of planar portions. The plurality of planar portions is arranged such that when a force (e.g., a torque) is applied to the body, the applied force is directed toward the plurality of teeth.

In accordance with a second aspect, an actuator assembly is provided. The actuator assembly includes a housing, a drive shaft at least partially disposed in the housing, and a drive gear operably coupled to the drive shaft. The drive gear includes a body, a skirt that extends outwardly from a perimeter of the body, a plurality of teeth that extend outwardly from the body along a portion of the perimeter of the body, and an opening that extends through the body and is arranged to receive a portion of the drive shaft. The opening is defined by an inner surface of the body, wherein the inner surface is arranged such that a force (e.g., a torque) applied to the body is directed toward the plurality of teeth. The actuator assembly also includes a labyrinth defined by the cooperation between the housing and the skirt of the body of the drive gear, the labyrinth configured to direct fluid flow away from the drive gear.

In accordance with a third aspect, an actuator assembly is provided. The actuator assembly includes a housing, an actuator disposed in the housing, a drive shaft operably coupled to the actuator, and a drive gear operably coupled to the drive shaft. The drive gear includes a body, a skirt that extends transversely from a perimeter of the body, a plurality of teeth, and an opening. The plurality of teeth extends outwardly from the body along a portion of the perimeter of the body. The opening extends through the body and is arranged to receive a portion of the drive shaft. The opening is also defined by an inner surface of the body that is arranged such that a force (e.g., torque) applied to the body is directed toward the plurality of teeth. The housing comprises a plurality of troughs being oriented to direct fluid flow away from the drive shaft.

In further accordance with the foregoing first, second, and/or third aspects, a drive gear or an actuator assembly may further include any one or more of the following preferred forms.

In one preferred form, the plurality of rounded portions includes a first rounded portion and a second rounded portion. The first rounded portion includes a first arc length and the second rounded portion includes a second arc length that is greater than the first arc length.

In another preferred form, the plurality of planar portions includes a first planer portion and a second planar portion. The first planar portion extends between the first and second rounded portions and the second planar portion extends between the first and second rounded portions. The first and second planar portions extend from the second rounded portion to the first rounded portion such that the first and second planar portions converge toward one another in a direction toward the plurality of teeth.

In another preferred form, the first rounded portion of the plurality of rounded portions is disposed closer to the plurality of teeth than the second rounded portion of the plurality of rounded portions.

In another preferred form, at least one rounded portion of the plurality of rounded portions is offset from a central axis of the body.

In another preferred form, the plurality of teeth extends outwardly from the body for a distance thereby forming a lip extending from the body. The lip extends from a first end of the plurality of teeth to a second end of the plurality of teeth.

In another preferred form, a height of the plurality of teeth is greater than a height of the body.

In another preferred form, a seal is disposed in the housing and surrounding the drive shaft proximate to the drive gear.

In another preferred form, the housing includes a plurality of troughs oriented to direct fluid flow away from the drive shaft.

In another preferred form, the inner surface of the body includes a plurality of planar portions and a plurality of rounded portions extending between the plurality of planar portions.

### DETAILED DESCRIPTION

The present disclosure is directed to an actuator assembly that maximizes fatigue strength and mechanical endurance and provides ingress protection against, for example, accidental fluid spills or splashes in food and beverage applications, commercial vehicle applications, and other industrial applications. More particularly, the actuator assembly includes a drive gear that is configured to absorb forces, such as, for example, torsional loads generated at specific radial distances by an external drive mechanism, applied to the drive gear during operation in a manner that maximizes the fatigue strength and mechanical endurance of the drive gear. For example, when the drive gear is operably coupled to the external drive mechanism (e.g., a rack and pinion, a lever, a linkage, or a belt), torsional loads received by the drive gear from the external drive mechanism are directed toward a particular portion of the drive gear having a higher strength than a remainder of the drive gear. For example, the torsional loads received by the drive gear from the external drive mechanism are directed toward a highly stressed output shaft or an external gear hub interface. The drive gear is also configured to interface with the housing of the actuator assembly in a manner that minimizes, if not eliminates, fluid and/or debris ingress into the actuator assembly during use.

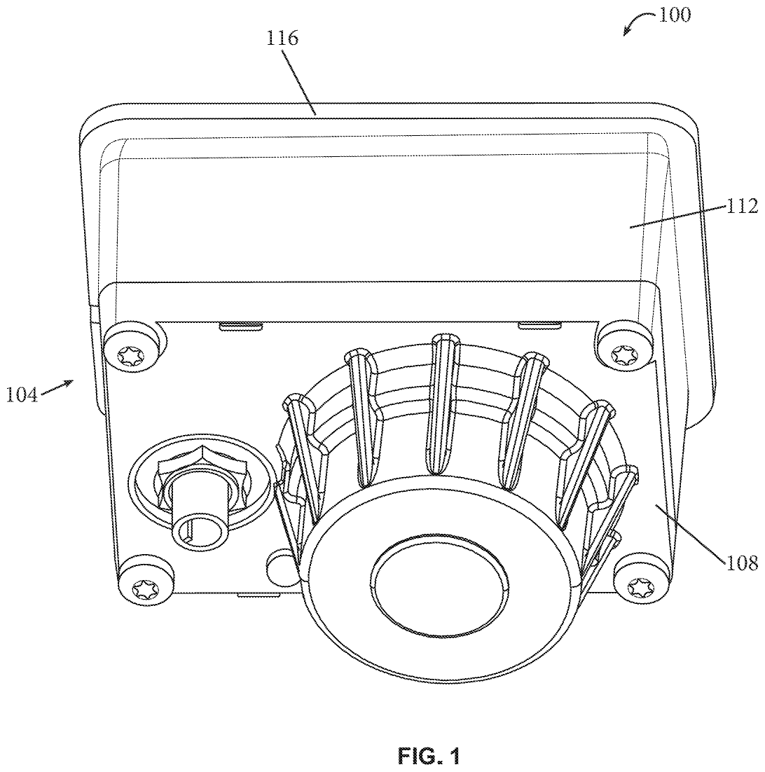

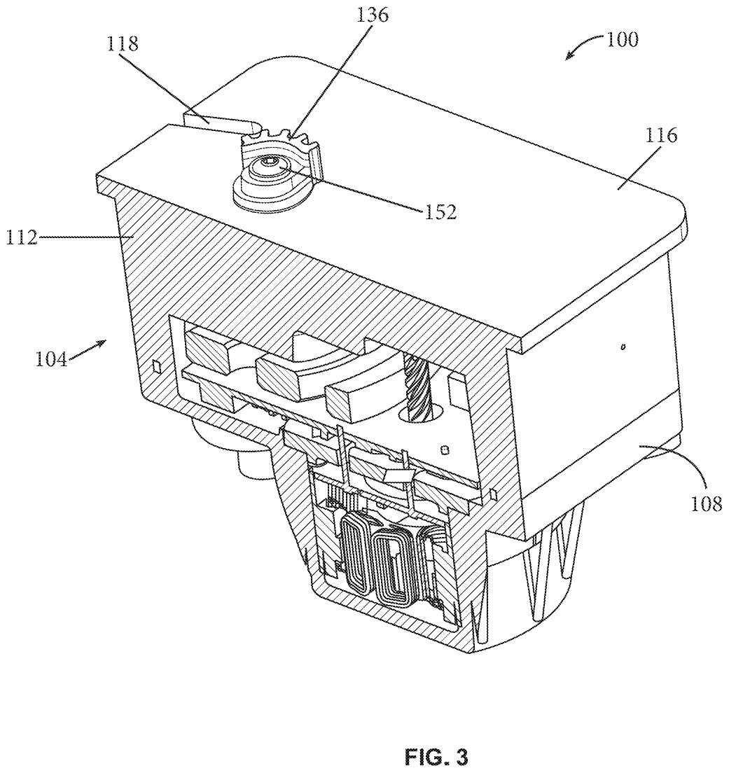

FIGS. 1-6 illustrate one example of an actuator assembly 100 constructed in accordance with the principles of the present disclosure. As illustrated, the actuator assembly 100 generally includes, among other elements, a housing 104 that retains and secures various mechanical and electrical components, as will be discussed in more detail below. The actuator assembly 100 also generally includes an actuator 128, an output shaft 132 operably coupled to the actuator 128, a drive assembly 140 operably coupled to the output shaft 132, and a drive gear 136 operably coupled to the output shaft 132 (and the actuator 128) via the drive assembly 140, with each of these components at least partially disposed in the housing 104. In other examples, the actuator assembly 100 can include more, less, or different components.

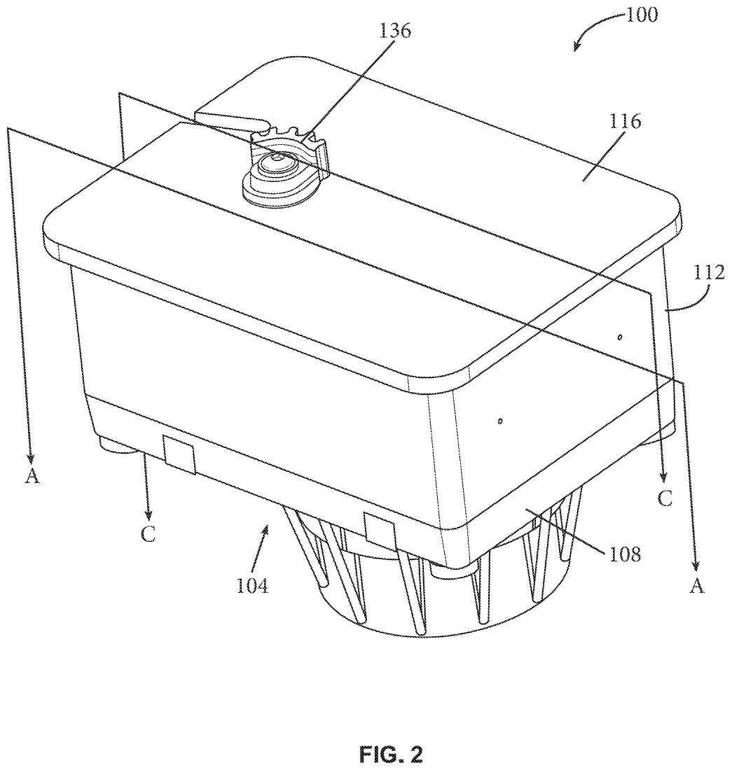

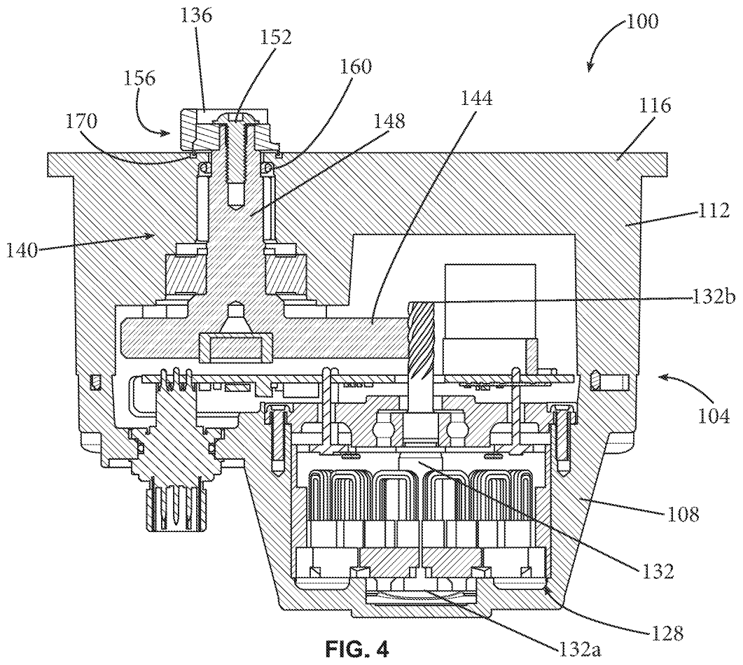

The housing 104 generally includes a first portion 108 and a second portion 112 that are coupled to one another. In this example, the first portion 108 and the second portion 112 are coupled to one another via fasteners (FIG. 1). As best illustrated in FIG. 4, the actuator 128 and the output shaft 132 are at least partially disposed within the first portion 108. As best illustrated in FIGS. 1 and 2, the actuator assembly 100 also includes a labyrinth 116 configured to direct fluid flow away from the drive assembly 140 and a plurality of troughs 118 formed within the housing 104 such that the plurality of troughs 118 direct fluids flowing into the second portion 112 of the housing 104 away from certain areas of the actuator assembly 100 (e.g., the drive assembly 140 and other components disposed in the second portion 112 of the housing 104). In this example, the labyrinth 116 is defined by the cooperation between the housing 104 (and more particularly the second portion 112) and the drive gear 136. Meanwhile, in this example, the plurality of troughs 118 are formed in the second portion 112 of the housing 104 such that the plurality of troughs 118 extends only partially through the second portion 112. In other examples, the labyrinth 116 can be defined differently (e.g., by different components) and/or the troughs 118 can extend differently (e.g., entirely through the labyrinth 116) so as to direct fluids away from the drive assembly 140 and other components disposed in the second portion 112 of the housing 104 in a different manner. In any event, the plurality of troughs 118 of the labyrinth 116 are configured to direct fluid flow away from openings or other vital features of the actuator assembly 100, thereby mitigating, if not completely preventing, the ingress of fluid into the housing 104 of the actuator assembly 100.

As best illustrated in FIG. 4, the actuator 128 is placed within the housing 104 such that the actuator 128 is disposed between the first and second portions 108, 112 of the housing 104. In other examples, the actuator 128 can instead be positioned elsewhere within the housing 104. In this example, the actuator 128 is an electric actuator. In other examples, the actuator 128 can instead be a mechanical actuator, a pneumatic actuator, a hydraulic actuator, or some other suitable actuator.

The output shaft 132 is generally an elongated structure disposed within the housing 104 in a manner that transmits rotational energy from the actuator 128 component to the drive assembly 140. In this example, the output shaft 132 includes a first end 132a operably coupled to the actuator 128 and a second end 132b operably coupled to the drive assembly 140. The first end 132a of the output shaft 132 is disposed in the first portion 108 of the housing 104 and the second end 132b of the output shaft 132 is disposed in the second portion 112 of the housing 104. In other examples, however, the output shaft 132 can be arranged in a different manner. As illustrated in FIG. 4, because the actuator 128 is disposed in the first portion 108 of the housing 104, the output shaft 132 extends from the first portion 108 of the housing 104 to the second portion 112 of the housing 104. In other examples, e.g., when the actuator 128 is disposed in the second portion 112 of the housing 104, the drive shaft 132 can extend from the second portion 112 of the housing 104 to the first portion 108 of the housing 104. It will be appreciated that the orientation of the output shaft 132 depends on the placement of the electronic actuator 128 in the housing 104.

The drive assembly 140 is at least partially disposed within the housing 104 and generally includes a first gear 144, a drive shaft 148 coupled to the first gear 144, and a securement mechanism 152 for coupling the drive gear 136 and, while not illustrated herein, the external drive mechanism to the drive shaft 148. The first gear 144 is coupled to the output shaft 132, such that the drive assembly 140 is controlled (e.g., rotated) by the output shaft 132. The drive shaft 148 extends vertically from the first gear 144 such that a portion of the drive shaft 148 extends through an opening 156 in the second portion 112 of the housing 104. The drive shaft 148 of the drive assembly 140 is in turn partially disposed outside of the housing 104, which allows the drive shaft 148 to form a physical connection with the object outside of the housing 104. Because forces are transferred from the actuator 128 to the object (and vice-versa) via the physical connection formed between the drive shaft 148 and the object outside of the housing 104, it is therefore desirable that the securement mechanism 152 couples the drive shaft 148 to the object or other system in a secure manner that allows for the transmission of most, if not all, these forces. For example, as illustrated in FIGS. 4-6, the securement mechanism 152 is a fastener for securing the drive gear 136 to the drive shaft 148. However, in other examples, the securement mechanism 152 may instead be a snap-fit, a nut and bolt, an adhesive, a threaded fitting, or any other known mechanical securement mechanism.

The actuator assembly 100 also includes a seal 160 that substantially prevents fluid and/or debris from entering the opening 156 and passing between the drive shaft 148 and the second portion 112 of the housing 104. As illustrated in FIGS. 4-6, the seal 160 is disposed around the drive shaft 148 near the opening 156 in the second portion 112 of the housing 104 and near the drive gear 136. However, constant rotation of the drive shaft 148 wears down the seal 160, thereby lowering the efficacy of the seal 160 in preventing fluid and/or debris from entering the housing 104 (i.e., the ingress of fluid and/or debris). It is therefore desirable to have an additional mechanism for preventing the ingress of fluid and/or debris into the housing 104 should the seal 160 lose efficacy due to the normal wear and tear experienced by the actuator assembly 100 in use. One such example of an additional mechanism for preventing the ingress of fluid and/or debris into the housing 104 is the drive gear 136.

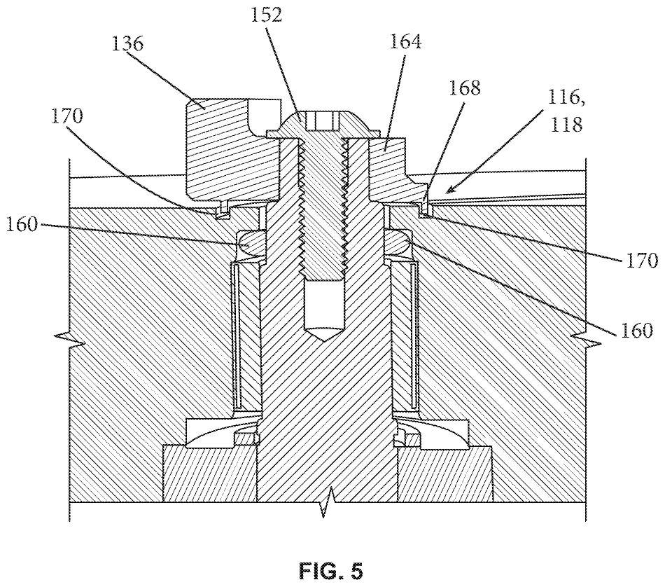

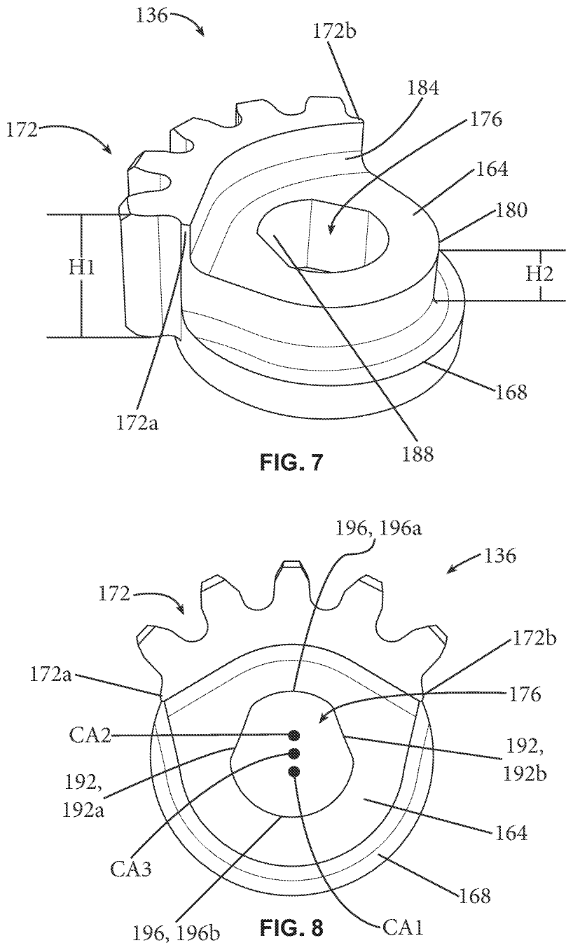

The drive gear 136 cooperates with a portion of the housing 104 to further prevent the ingress of fluid and/or debris into the housing 104. As best illustrated in FIGS. 5-10, the drive gear 136 includes a body 164, a skirt 168 extending outwardly from a perimeter 180 of the body 164, a plurality of teeth 172 extending from the body 164, and an opening 176 extending through the body 164. As illustrated in FIGS. 5-8, the skirt 168 extends radially outward from the body 164 and extends axially outward (downward in FIG. 7) from the body 164. In other examples, the skirt 168 can extend in a different manner. For example, the skirt 168 may extend either only radially outward from the body 164 or axially outward from the body 164. In any case, by extending outwardly from the body 164 as illustrated, the skirt 168 is arranged to be at least partially disposed in an opening 170 in the second portion 112 of the housing 104 at a position radially outward of the opening 156, the seal 160, and the drive shaft 148. The cooperation or interaction between the skirt 168 and the opening 170 in turn defines the labyrinth 116, which serves to substantially prevent fluid and/or debris from flowing between the second portion 112 of the housing 104 and the drive gear 136 and into the opening 156. While not illustrated herein, in other examples, the labyrinth 116 may also employ a seal (e.g., an o-ring coupled to the skirt 168) to further prevent fluid and/or debris from entering the housing 104. In any case, so configured, the labyrinth 116 can seal the opening 156 to the IP65 standard, for example, thereby preventing water (e.g., dripping water, spraying water, water jets), other fluids, and/or particulates (e.g., dust) from entering the opening 156.

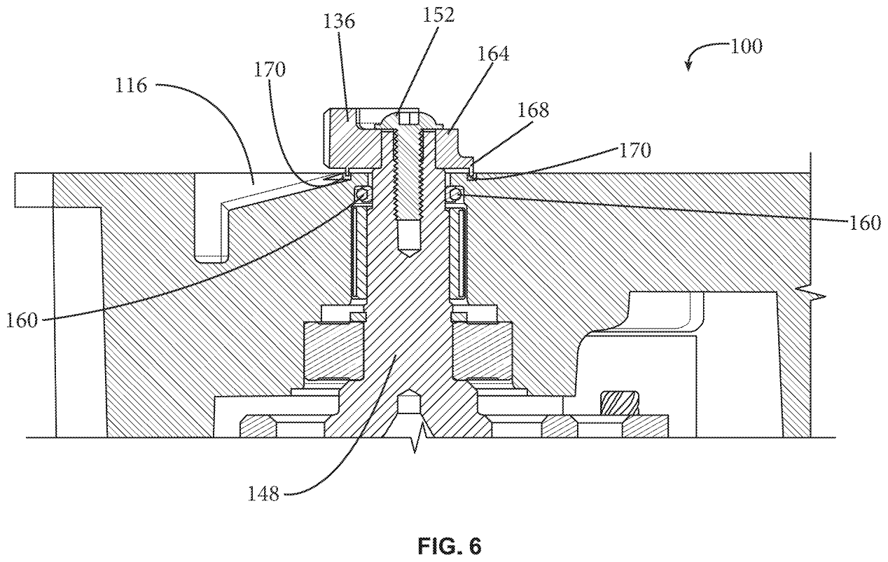

However, fluid and/or debris may nonetheless pass between the second portion 112 of the housing 104 and the skirt 168 of the drive gear 136 and still remain at or near the opening 156. Thus, the plurality of troughs 118 are oriented to direct that fluid and/or debris generally away from the opening 156. As best illustrated in FIG. 6, which depicts one of the troughs 118, the troughs 118 are oriented in a direction that extends radially outward and axially outward (downward in FIG. 6) from the opening 156. The troughs 118 may direct the fluid and/or the debris entirely out of the housing 104 (and more particularly the second portion 112) or may just direct the fluid and/or the debris to a position still within the housing 104 but away from the opening 156. Additionally, as illustrated in FIG. 6, the troughs 118 are in fluid communication with the labyrinth 116 to direct the fluid and/or debris out of the housing 104.

As discussed above, the labyrinth 116 in this example is defined by the skirt 168 of the drive gear 136 extending from the drive gear 136 and into the housing 104. However, in other examples, the labyrinth 116 can instead be defined by a skirt or other projection that extends from the housing 104 and into the drive gear 136. The projection extending from the housing 104 and into the drive gear 136 can in turn seal the opening 156 to the IP65 standard, for example, thereby preventing water (e.g., dripping water, spraying water, water jets), other fluids, and/or particulates (e.g., dust) from entering the opening 156.

While the drive gear 136 helps to define the labyrinth 116 that prevents the ingress of fluid and/or debris, the drive gear 136 may also tangentially absorb a rotational load through the thickest and strongest section of the drive gear 136 thereby driving torque in a small radius where fatigue or cycle strength may be an issue.

As illustrated in FIGS. 7-9, the plurality of teeth 172 are disposed along only a portion of the perimeter 180 of the body 164 and facilitate a mechanical connection with the external drive mechanism. For example, the plurality of teeth 172 may facilitate a mechanical connection with a rack and pinion or another external drive mechanism such as a lever, a linkage, or a belt. Accordingly, while FIGS. 7-10 depict the drive gear 136 as including five (5) individual teeth, in other examples the drive gear 136 may include more or less teeth depending on the type of mechanical connection or the external structure. Additionally, as illustrated in FIG. 10 the plurality of teeth 172 have a height H1 that is greater than a height H2 of the body 164. As illustrated in FIG. 7, the difference in height between the height H1 of the plurality of teeth 172 and the height H2 of the body 164 forms a lip 184 that extends between the body 164 and the plurality of teeth 172. The lip 184 extends only along a portion of the height H1 of the plurality of teeth 172. More particularly, as illustrated in FIG. 7, the lip 184 extends along the portion of the height H1 of the plurality of teeth 172 that is disposed above the body 164 of the drive gear 136. Further, because the plurality of teeth 172 are disposed along only the portion of the perimeter 180 of the body 164, the lip 184 also extends only along the portion of the perimeter 180 of the body 164. More particularly, the lip 184 extends from a first end 172a of the plurality of teeth to a second end 172b of the plurality of teeth 172. As best illustrated in FIG. 8, the lip 184 in this example extends from the first end to the second end 172a, 172b of the plurality of teeth 172 in a curvilinear manner. In other examples, however, the lip 184 can extend between the first and second ends 172a, 172b of the plurality of teeth 172 along a spline, a straight line, a curve, etc.

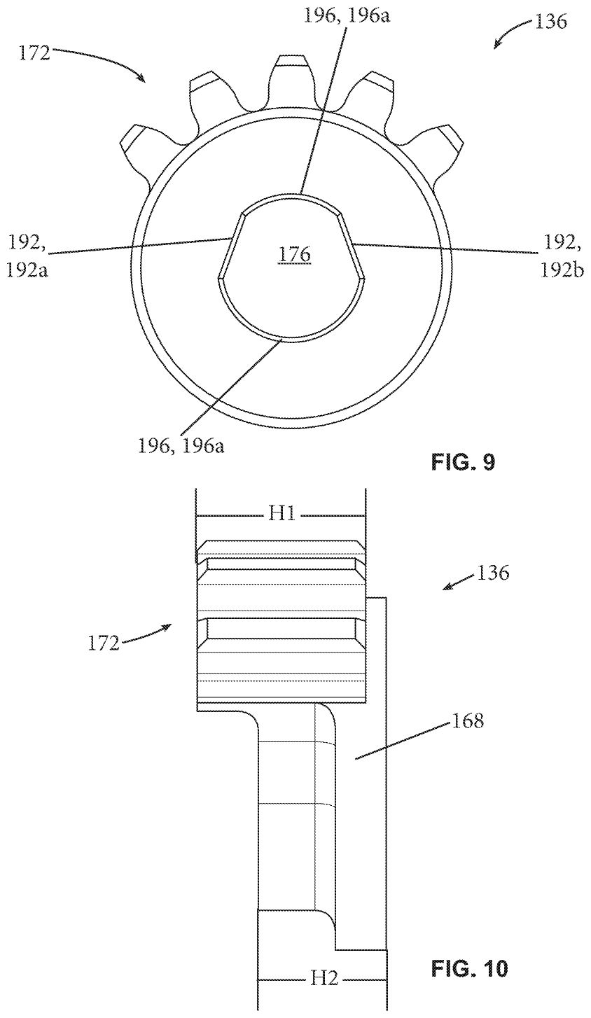

As illustrated in FIGS. 8 and 9, the opening 176 of the drive gear 136 is defined by an inner surface 188 of the body 164 that is configured such that a force (e.g., a torque) applied to the body 164 is directed toward the plurality of teeth 172. In this example, this is accomplished because the inner surface 188 create a “double-D” interface. The “double-D” interface is defined by a plurality of planar portions 192 and a plurality of rounded portions 196 of the inner surface 188.

The plurality of rounded portions 196 includes a first rounded portion 196a and a second rounded portion 196b. The first rounded portion 196a has a first arc length and the second rounded portion 196c has a second arc length that is greater than the first arc length. The first rounded portion 196a is disposed closer to the plurality of teeth 172 than the second rounded portion 196b, though that need not be the case. For example, the second rounded portion 196b can be disposed closer to the plurality of teeth 172 than the first rounded portion 196a. Further, in this example, a central axis CA1 (FIG. 8) of the first rounded portion 196a and a central axis CA2 (FIG. 8) of the second rounded portion 196b are not aligned with a central axis CA3 (FIG. 8) of the opening 176. In other words, at least one axis of the plurality of rounded portions may be offset from the central axis CA3 (FIG. 8) of the opening 176.

The plurality of planar portions 192 includes a first planar portion 192a and a second planar portion 192b, both of which extend between the first and second rounded portions 196a, 196b. In particular, the first and second planar portions 192a, 192b extend from the second rounded portion 196b to the first rounded portion 196a (and toward the plurality of teeth 172) such that the first and second planar portions 192, 192b converge toward one another. In this manner, when, for example, a torque is applied to the body 164 of the drive gear 136, that torque is directed toward the plurality of teeth 172. While the first and second planar portions 192a, 192b are illustrated as including the same length, the first and second planar portions 192a, 192b may have varying lengths.

Accordingly, as torsional loads and other forces are applied to the drive gear 136 during operation, the orientation of the drive gear 136 (and more particularly the plurality of planar portions 192) directs those forces toward the plurality of teeth 172, which is the thicker, stronger portion of the drive gear 136. For example, the radial forces generated by the drive torque and output gear load are directed outwardly, toward the plurality of teeth 172. In other examples, however, the drive gear 136 may be oriented to direct radial forces toward different portions of the drive gear 136 that are strong enough to adequately withstand those forces.

What is claimed is:

1. A drive gear adapted to be disposed in a gear box, the drive gear comprising:
a body having a perimeter;
a skirt that extends outwardly from the perimeter of the body;
a plurality of teeth that extend outwardly from the body, the plurality of teeth extending along a portion of the perimeter of the body; and
an opening extending through the body, the opening defined by an inner surface of the body, the inner surface having a plurality of planar portions and a plurality of rounded portions extending between the plurality of planar portions,
wherein the plurality of planar portions is arranged such that a torque applied to the body is directed toward the plurality of teeth.

2. The drive gear of claim 1, wherein the plurality of rounded portions comprises:
a first rounded portion, the first rounded portion having a first arc length; and
a second rounded portion, the second rounded portion having a second arc length that is greater than the first arc length.

3. The drive gear of claim 2, wherein the plurality of planar portions comprises:
a first planar portion, the first planar portion extending between the first and second rounded portions; and
a second planar portion, the second planar portion extending between the first and second rounded portions,
wherein the first and second planar portions extend from the second rounded portion to the first rounded portion such that the first and second planar portions converge toward one another in a direction toward the plurality of teeth.

4. The drive gear of claim 2, wherein the first rounded portion of the plurality of rounded portions is disposed closer to the plurality of teeth than the second rounded portion of the plurality of rounded portions.

5. The drive gear of claim 1, wherein at least one rounded portion of the plurality of rounded portions is offset from a central axis of the body.

6. The drive gear of claim 1, wherein the plurality of teeth extends outwardly from the body for a distance, thereby forming a lip extending from the body, the lip extending from a first end of the plurality of teeth to a second end of the plurality of teeth.

7. The drive gear of claim 1, wherein a height of the plurality of teeth is greater than a height of the body.

8. An actuator assembly, comprising:
a housing;
a drive shaft at least partially disposed in the housing;
a drive gear operably coupled to the drive shaft, the drive gear having:
a body;
a skirt that extends outwardly from a perimeter of the body;
a plurality of teeth that extend outwardly from the body, the plurality of teeth extending along a portion of the perimeter of the body;
an opening extending through the body and arranged to receive a portion of the drive shaft, the opening defined by an inner surface of the body, wherein the inner surface is arranged such that a force applied to the body is directed toward the plurality of teeth; and
a labyrinth defined by the cooperation between the housing and the skirt of the body of the drive gear, the labyrinth configured to direct fluid flow away from the drive shaft.

9. The actuator assembly of claim 8, further comprising a seal disposed in the housing and surrounding the drive shaft proximate to the drive gear.

10. The actuator assembly of claim 8, wherein the housing comprises a plurality of troughs, the plurality of troughs being oriented to direct fluid flow away from the drive shaft.

11. The actuator assembly of claim 8, wherein the inner surface of the body includes a plurality of planar portions and a plurality of rounded portions extending between the plurality of planar portions, wherein the plurality of planar portions is arranged such that the force applied to the body is directed toward the plurality of teeth.

12. An actuator assembly, comprising:
a housing;
an actuator disposed in the housing;
a drive shaft operably coupled to the actuator; and
a drive gear operably coupled to the drive shaft, the drive gear comprising:
a body;
a skirt that extends outwardly from a perimeter of the body;
a plurality of teeth that extend outwardly from the body, the plurality of teeth extending along a portion of the perimeter of the body; and
an opening extending through the body and arranged to receive a portion of the drive shaft, the opening defined by an inner surface of the body, wherein the inner surface is arranged such that a torque applied to the body is directed toward the plurality of teeth, and
wherein the housing comprises a plurality of troughs being oriented to direct fluid flow away from the drive shaft.

13. The actuator assembly of claim 12, further comprising a seal defined by the cooperation between the housing and the skirt of the body of the drive gear, the labyrinth configured to direct fluid flow away from the drive shaft.

14. The actuator assembly of claim 12, wherein the inner surface comprises a plurality of planar portions and a plurality of rounded portions extending between the plurality of planar portions, and wherein the plurality of planar portions is arranged such that when the body receives the torque, the torque is concentrated on the body toward the plurality of teeth.

15. The actuator assembly of claim 14, wherein the plurality of rounded portions comprises a first rounded portion and a second rounded portion.

16. The actuator assembly of claim 15, wherein the first rounded portion of the plurality of rounded portions is disposed closer to the plurality of teeth than the second rounded portion of the plurality of rounded portions.

17. The actuator assembly of claim 14, wherein at least one rounded portion of the plurality of rounded portions is offset from a central axis of the body.

18. The actuator assembly of claim 15, wherein the first rounded portion of the plurality of rounded portions is disposed proximate the plurality of teeth and the second rounded portion of the plurality of rounded portions is disposed opposite the first rounded portion.

19. The actuator assembly of claim 12, wherein the plurality of teeth extends outwardly from the body for a distance, thereby forming a lip extending from the body, the lip extending from a first end of the plurality of teeth to a second end of the plurality of teeth.

20. The actuator assembly of claim 12, wherein the drive gear is releasably secured to the drive shaft.
